(19) United States
(12) Patent Application Publication
(10) Pub. No.: US 2018/0078065 A1
(43) Pub. Date: Mar. 22, 2018

(54) VESSEL USE-TRACKING SYSTEM AND METHOD

(71) Applicant: Natural Ventures LLC, Kirkland, WA (US)

(72) Inventors: Benjamin Curtis Cheatham, Kirkland, WA (US); Joel Patrick Buss, Woodinville, WA (US)

(21) Appl. No.: 15/711,296

(22) Filed: Sep. 21, 2017

Related U.S. Application Data
(60) Provisional application No. 62/397,699, filed on Sep. 21, 2016.

(51) Int. Cl. A47G 19/22; G09F 3/02; G01F 19/00; A47G 23/16; G06Q 20/00

(52) U.S. Cl. CPC A47G 19/2227; G09F 3/02; G06Q 20/00; A47G 23/16; G01F 19/00

(57) ABSTRACT

The disclosure includes a use-tracking vessel that comprises a vessel body that defines a vessel cavity via sidewalls, a level sensor to sense an amount of liquid present within the vessel cavity, and a communication device to communicate data. The vessel can obtain and store data indicating a volume of fluid present in the vessel cavity over time. The disclosure also includes a method of vessel use tracking that comprises obtaining data from a plurality of vessels indicating a volume of fluid present in respective vessel cavities of the vessels over time and identifying one or more use-events associated with the respective vessels based at least in part on the received data indicating a volume of fluid present in the respective vessel cavities of the vessels over time.

### CROSS-REFERENCE TO RELATED APPLICATIONS

This application is a non-provisional of and claims the benefit of U.S. Provisional Application No. 62/397,699, filed Sep. 21, 2016, which application is hereby incorporated herein by reference in its entirety and for all purposes.

### BRIEF DESCRIPTION OF THE DRAWINGS

FIG. 1 is an exemplary network diagram illustrating an embodiment of a vessel use-tracking system.

FIG. 2 is an exemplary perspective see-through drawing illustrating an embodiment of a vessel.

FIG. 3 is an exemplary block diagram illustrating an embodiment of components of a vessel.

FIG. 4 is a block diagram of a method of determining an amount of resource savings.

FIG. 5 is a block diagram of a method of billing use-events of a vessel.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

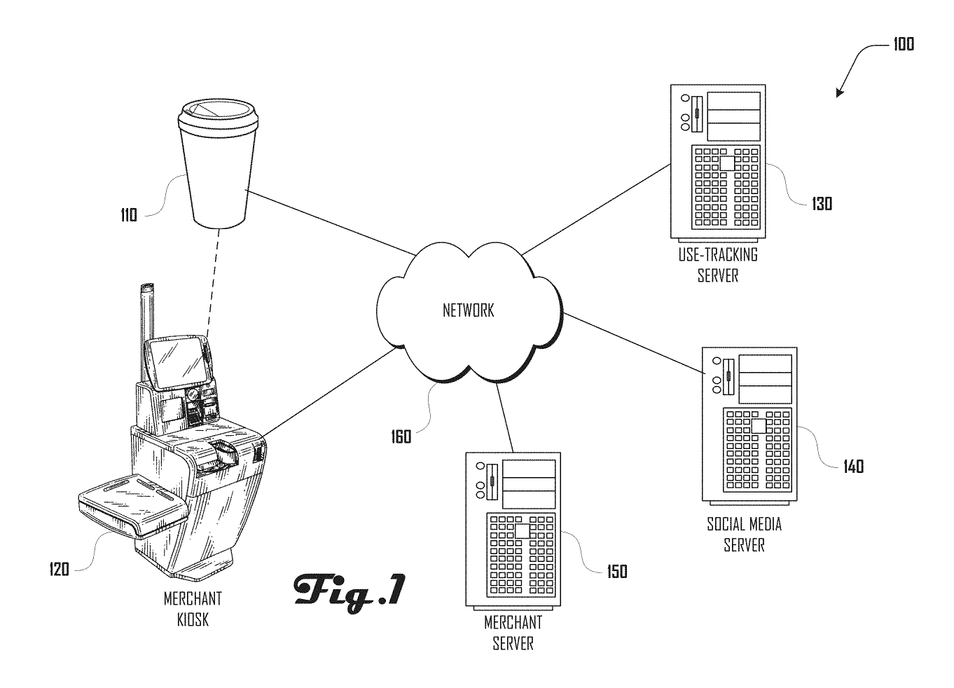

Since currently-available vessels lack robust tracking functionalities, a vessel use-tracking system 100 can prove desirable and provide a basis for a wide range of applications, such as determining an amount of resource savings based on use of the vessel and billing use-events of a vessel. This result can be achieved, according to one embodiment disclosed herein, by a vessel use-tracking system 100 as illustrated in FIG. 1.

Turning to FIG. 1, the vessel use-tracking system 100 is shown as comprising a vessel 110, a merchant kiosk 120, a use-tracking server 130, a social media server 140 and a merchant server 140, which are operably connected via a network 160. Additionally, the vessel 110 and merchant kiosk 120 can also be directly operably coupled in various suitable ways as described in more detail herein.

In some examples described herein, the vessel 110 can comprise a coffee mug configured to hold hot and/or cold beverages. However, although many of the following examples relate to a coffee mug vessel 110 configured to be hand-held and carried by a user, it should be clear that further embodiments can relate to any suitable type of vessel 110 of any suitable size, shape and configured for any suitable purpose. For example, while various examples relate to tracking volumes of liquid present in the vessel 110 over a period of time, further examples can relate to tracking volumes of fluids and/or solids. Accordingly, in some embodiments, the vessel 110 can comprise a plate, cup, dish, soap dispenser, fork, knife, spoon, food container, water bottle, growler, or the like.

The merchant kiosk 120 can similarly comprise various suitable devices in some embodiments and while the merchant kiosk 120 of FIG. 1 is illustrated as being a checkout station suitable for use in a retail store, in further embodiments the merchant kiosk 120 can comprise various suitable devices. For example, in some embodiments, the merchant kiosk 120 can comprise a laptop computer, desktop computer, tablet computer, smartphone, wearable computer, gaming device, media device, or the like.

The use-tracking server 130, social media server 140, and merchant server 150 can comprise various types of suitable servers and in some examples can comprise virtual machines, or the like. The network 160 can comprise one or more suitable types of wired and/or wireless networks including the Internet, a Wide Area Network (WAN), a Local Area Network (LAN), a Personal Area Network (PAN), a WiFi network, a Bluetooth network, a cellular network, an infrared wireless network (e.g. an Infrared Data Association network (IrDA)), and Ultra Wide Band (UWB) network, a wireless induction network, a Zigbee network, or the like. Similarly, the vessel 110 and merchant kiosk 120 can communicate in various suitable ways including via a barcode, Radio Frequency Identification (RFID) device, a WiFi network, a Bluetooth network, or the like.

In accordance with various embodiments, the vessel use-tracking system 100 can be configured to track use of the vessel 110 and specifically track volumes of liquids such as beverages entering and/or leaving the vessel 110. Where the vessel 110 is reusable, such tracking of liquids can be used to determine a number of one-time use containers being saved by the user by using the reusable vessel 110 instead of using one-time use containers.

For example, users may have the option of using one-time use containers such as paper or plastic cups when drinking a beverage such as coffee. Many coffee drinkers will drink numerous cups of coffee a day and where the drinker uses the reusable vessel 110 instead of single-use cups, many hundreds of single-use cups will be saved per year. Accordingly, by tracking use of the reusable vessel 110 a determination can be made regarding a number of single-use cups saved by such use over a period of time. Such tracking and savings determination by the vessel use-tracking system 100 is described in more detail herein.

While one example configuration of a use-tracking system 100 is illustrated in FIG. 1, this should not be construed to be limiting on the wide variety of alternative embodiments that are within the scope and spirit of the present disclosure. For example, any of the elements of the use-tracking system 100 shown in FIG. 1 can be present in a suitable plurality or can be absent in accordance with some embodiments. For example, various embodiments can comprise a plurality of vessels 110 associated with one or more user and a plurality of merchant kiosks 120 with which the plurality of vessels 110 can interact with.

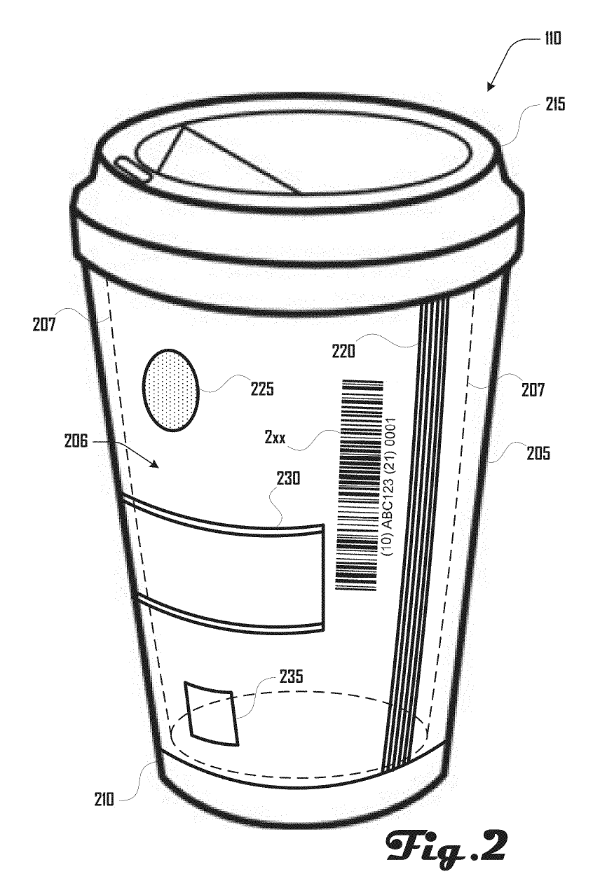

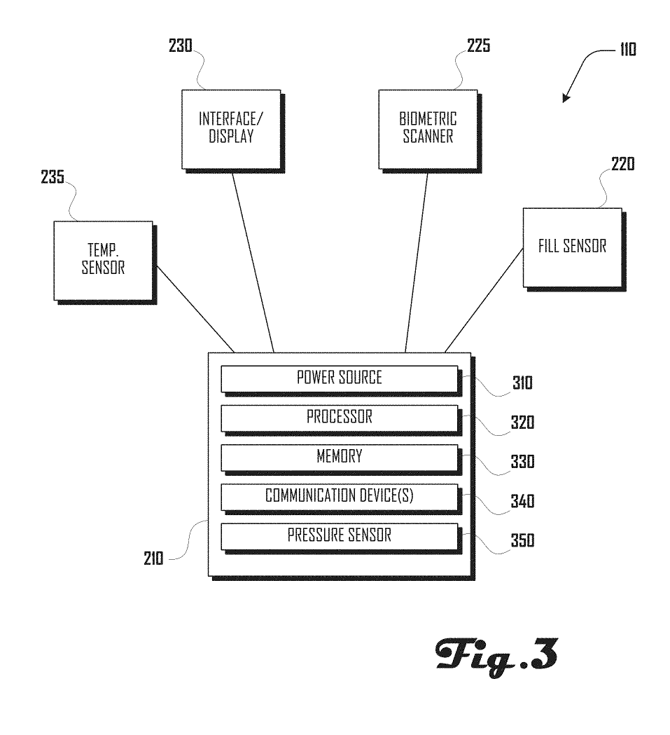

Turning to FIG. 2, an example embodiment of a vessel 110 is illustrated, which comprises a vessel body 205, which defines a cavity 206 via sidewalls 207. The vessel 110 can further comprise a base unit 210, a lid 215, a level sensor 220, a biometric scanner 225, a display 230, a temperature sensor 235, and a unique identifier 240 (e.g., a bar code). As illustrated in FIG. 3, the level sensor 220, a biometric scanner 225, a display 230, and a temperature sensor 235 can be operably connected to the base unit 210, which can comprise a power source 310, processor 320, a memory 330, a communication device 340 and a pressure sensor 350.

As illustrated in FIG. 2, the level sensor 220 can extend between a bottom end and top end of the vessel 110 and be configured to sense an amount of liquid present within the cavity 206. For example, the level sensor 220 can be configured to identify the top level of liquid within the cavity 206 by identifying a first portion of the level sensor 220 that is not in contact with liquid and a second portion that is in contact with liquid, and a determination can be made that a third portion between the first and second portion defines the top level of a volume of liquid within the cavity 206 of the vessel 110. Accordingly, given a known volume of liquid at various top levels, a top level of the volume of liquid can be used to determine a volume of the liquid present in the cavity 206.

The biometric sensor 225 can be disposed on an external portion of the body 205 and can comprise a fingerprint reader, which in various embodiments can be used to identify a user of the vessel 110, log into a user account, unlock or lock functionalities of the vessel 110, and the like. In some embodiments, the biometric sensor 225 can comprise or define an interface that can include sensing swipe gestures, pressing, or the like.

The display 230 can be disposed on an external portion of the body 205 and can comprise any type of suitable display, including a touch screen display, back-lit screen, LED screen, or the like. Such a display 230 can have any suitable resolution, including low, medium or high resolution. In further embodiments, the display 230 can be a simple display such as one or more light or can be a complex display such as a full color touch-screen.

In some embodiments, a display 230 and/or interface can be external to the vessel 110. For example, in one embodiment, a smartphone, merchant kiosk 120 or other suitable device can present a display and/or interface corresponding to the vessel 110. In other words, in some embodiments, a user can interact with the vessel 110 via an external device such as a smartphone or the like. Additionally, in further embodiments, a user can interact with the vessel 110 (directly or via an intermediary device) by voice, gesture, touch, or the like.

The temperature sensor 235 can be configured to sense a temperature of a fluid disposed within the cavity 206 of the vessel 110. For example, in some embodiments the temperature sensor 235 can define a portion of a sidewall 207 and may or may not be configured to be directly exposed to a fluid present within the cavity 206 of the vessel 110. In various embodiments, the temperature sensor 235 can be disposed on a lower portion of the vessel 110 near the base 210.

The unique identifier 240 can include a visual unique identifier such as a line bar code as shown in FIG. 2, but can also include a matrix barcode (e.g., a Quick Response Code or QR Code), three dimensional barcode, or other visual indicator associated with such a unique identifier 240. Additionally, in further embodiments, a unique identifier 240 or an identifier associated with a unique identifier 240 can be stored in a Radio Frequency Identifier (RFID) device, the memory 330, or associated with hardware of the vessel 110 (e.g., a Medium Access Control (MAC) address, IP address, or the like). In various embodiments, such a unique identifier 240 can be static or changing over time. Additionally, in some embodiments, such a unique identifier 240 can be presented on the display 230.

In some embodiments, the base unit 210 can be removably coupled to a bottom portion of the vessel body 205. For example, where the base unit comprises components such as a power source 310, processor 320, a memory 330, a communication device 340 and a pressure sensor 350 as illustrated in FIG. 3, it can be desirable to remove the base unit 210 for purposes of washing the vessel body 205, charging the power source 310, and the like. Accordingly, in various embodiments, the base unit can be removably operably coupled to the level sensor 220, biometric scanner 225, display 230, and temperature sensor 235.

Additionally, in further embodiments, other portions of the vessel 110 can be removable. In one embodiment, a portion of the body 205 that defines the cavity 206 can be removable. For example, the vessel 110 can comprise a removable/washable insert (external housing), which can allow a user to remove a portion that defines the cavity 206 and/or non-sensitive electronics and wash the removable portion by hand, via a dishwasher, or the like.

The power source 310 can include any suitable power source such as a battery. In some embodiments, the power source 310 can comprise a replaceable battery, a rechargeable battery, a non-rechargeable battery, a kinetic charging system, solar power system, a thermoelectric generator, a power port (e.g., a Universal Serial Bus (USB) power port), a docking base, and the like. In one embodiment, the power source 310 can comprise a thermoelectric energy converter in an external housing or in a handle of the vessel 110, which can allow a user to charge a battery from heat from the user's hand, fluid present in the vessel 110, or the like.

The memory 330 can provide a computer-readable storage medium for storing basic programming and data constructs that may provide the functionality of at least one embodiment of the present disclosure. The applications (programs, code modules, instructions) that, as a result of being executed by one or more processors 320, can provide the functionality of one or more embodiments of the present disclosure, and may be stored in the memory 320. These application modules or instructions may be executed by the one or more processors 320. The memory 320 can additionally provide a repository for storing data used in accordance with the present disclosure. Additionally, the memory can be used for temporary or long-term storage of information such as details associated with sensing data related to the temperature sensor 235, the fill sensor 220, the biometric scanner 225, the pressure sensor 350, or the like.

The communication device(s) 340 can serve as an interface for receiving data from, and transmitting data to, other systems from the computing device vessel 110. For example, the communication device(s) 340 can enable communication via a wired and/or wireless network such that the vessel 110 can transmit and/or receive data while in a remote location from a second device, while proximate to a second device, while in contact with a second device, while wired to a second device, or the like.

The pressure sensor 350 can be configured to sense weight of a fluid present in the cavity 206 or can be configured to sense the absence of weight of a fluid present in the cavity 206. Accordingly, in some embodiments, where the level indicator 220 can be used to determine a volume of fluid present in the cavity 206, a further determination of weight of the fluid identified by the pressure sensor 350 can be used to determine a density of the fluid. However, in further embodiments the pressure sensor 350 can be used to identify a threshold weight or volume present in the cavity 206.

Although FIGS. 2 and 3 illustrate specific example embodiments of a vessel 110, it should be clear that further embodiments can include any suitable alternative configuration of such elements. For example, in some embodiments, any of the described elements can be absent, can be present in a plurality, or can be replaced with a suitable equivalent. Additionally, while certain elements are shown being disposed in the base 210 or body 205, in further embodiments, any of such elements can be suitably located in one or both of such portions of the vessel 110.

Furthermore, other embodiments can include any suitable additional elements including a heating element (e.g., to heat liquid in the cavity 206), a pH sensor, a gas pressure sensor, a camera (e.g., for use in identifying fluids and/or solids via machine vision), a system for controlling fluid temperature in the cavity (e.g., hot and/or cold temperature), and the like. Accordingly, the example embodiments of FIGS. 2 and 3 should not be construed to be limiting on the wide variety of variations contemplated that are within the scope and spirit of the present disclosure.

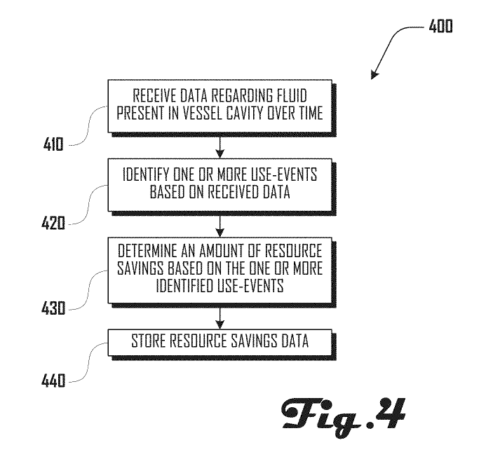

Turning to FIG. 4, a method 400 of determining an amount of resource savings is disclosed. The method 400 begins in block 410, where data regarding fluid present in a vessel cavity 206 over time is received. For example, data regarding fluid present in the vessel cavity 206 can comprise information such as fluid temperature, fluid weight, fluid fill level, fluid volume, density of the fluid, a type of fluid, and the like. Such data can be over any suitable time period including a range of milliseconds, seconds, minutes, hours, days, weeks, and the like. Additionally, such data can be in any suitable time increments including milliseconds, seconds, minutes or the like. In one example, where the vessel 110 comprises a fill sensor 220, a temperature sensor 235 and/or a pressure sensor 350 as illustrated in FIG. 3, such data regarding fluid present in the vessel cavity 206 can comprise, be based on, or be calculated from data received from such sensors. Additionally, in some embodiments, scanning a barcode or interrogating an RFID (e.g., a unique identifier 240) can be associated with a volume of fluid disposed in a vessel cavity 206 over time. For example, a single scan or interrogation can be associated with twelve ounces of fluid being present and removed over a period of time.

In block 420, one or more use-events are identified from the data regarding fluid present in the vessel cavity 206. For example, where a fill sensor 220 and temperature sensor 235 indicate that the vessel cavity 206 was empty for a first period of time, was filled with 12 ounces of liquid that was initially 180° F. for a second period of time, and then was empty at a third period of time, such a set of data could be determined to be associated with a use-event of a user drinking coffee or tea.

However, where a fill sensor 220 and temperature sensor 235 indicate that the vessel cavity 206 was empty for a first period of time, was filled with 12 ounces of liquid that was initially 40° F. for a second period of time, and then was empty at a third period of time, such a set of data could be determined to be associated with a use-event of a user drinking water or another type of cold beverage.

In various embodiments, use-events can have any suitable degree of specificity regarding the use-event. For example, in some embodiments, a use-event can correspond to an indication that fluid was present in the vessel cavity 206 for a period of time; that hot or cold fluid was present in the vessel cavity 206 for a period of time; that one of fruit juice, carbonated soda, coffee, tea, water or alcoholic beverage was present in the vessel cavity 206 for a period of time; that hot or cold fluid was present in the vessel cavity 206 for a period of time; and the like.

Additionally, various suitable filters can be applied to data when identifying use-events. For example, in some embodiments, fill-events can be capped at a maximum per minute, hour, day, week or the like, which can correspond to a biological consumption limit for human or non-human users, and the like. In some embodiments, suspect or potentially erroneous use-events can be flagged for review by an administrator and/or user.

Returning to the method 400, in block 430 an amount of resource savings is determined based on the one or more determined use-events and stored, in block 440. For example, where a use-event of a user drinking 12 ounces of coffee or tea is identified (e.g., fill sensor 220 and temperature sensor 235 indicate that the vessel cavity 206 was empty for a first period of time, was filled with 12 ounces of liquid that was initially 180° F. for a second period of time, and then was empty at a third period of time) a resource savings associated with such a use-event can comprise the savings of one 12-ounce cardboard hot beverage container, a cardboard heat sleeve and a plastic lid.

In another example, where a use-event of a user drinking 24 ounces of coffee or tea is identified (e.g., fill sensor 220 and temperature sensor 235 indicate that the vessel cavity 206 was empty for a first period of time, was filled with 24 ounces of liquid that was initially 180° F. for a second period of time, and then was empty at a third period of time) a resource savings associated with such a use-event could comprise the savings of one 24-ounce cardboard hot beverage container, a cardboard heat sleeve and a plastic lid.

In a further example, where a use-event of a user drinking 16 ounces of water is identified (e.g., fill sensor 220 and temperature sensor 235 indicate that the vessel cavity 206 was empty for a first period of time, was filled with 16 ounces of liquid that was initially 40° F. for a second period of time, and then was empty at a third period of time) a resource savings associated with such a use-event could comprise the savings of one 16.9 ounce plastic single-use water bottle.

Additionally, such a use-event can be expressed in terms of other suitable types of natural resources. For example, the savings of a plastic single-use water bottle can be expressed in terms of petroleum products used to manufacture the bottle, used to transport the water bottle to a store, and the like. Similarly, the savings of a cardboard cup and sleeve can be expressed in terms of number of trees saved.

In various embodiments, one or more of the devices of a vessel use-tracking system 100 can perform one or more of the steps shown and described relative to FIG. 4. For example, in one embodiment, the vessel 110 can receive data (e.g., from sensors 330, 235, 350 at the processor 320), identify use-events (e.g., by the processor 320), determine resource savings (e.g., by the processor 320), and store the resource savings (e.g., in the memory 330).

In various embodiments, resource savings determined by the vessel 110 can also be communicated to various devices such as the merchant kiosk 120, the use-tracking server 130, the social media server 140 and/or the merchant server 150. For example, the use-tracking server 130 can receive and store such resource savings data associated with a user profile of a user associated with the vessel 110. In other examples, a given user profile can be associated with one or more vessels 110 and the use-tracking server 130 can store data associated with a plurality of user profiles and vessels 110. In various embodiments, the re-use of vessels 110 can be tracked by merchants or other entities to track customer behavior and create incentivized measures for customer loyalty.

In further embodiments, resource savings determined by the vessel 110 can be communicated to the merchant kiosk 120, the use-tracking server 130, the social media server 140 and/or the merchant server 150 for purposes for rewards, badges and the like. For example, the resource savings generated by a user can be shared with the user's friends on Facebook or resource savings can be redeemed for coupons, cash rewards or the like, by a merchant.

In further embodiments, devices aside from the vessel 110 can perform processing as illustrated and discussed relative to FIG. 4. For example, in some embodiments, the vessel 110 can communicate data (e.g., via the communication device(s) 340), to the use-tracking server 130 which can identify use-events, determine resource savings, and store the resource savings data.

In further embodiments, data from the vessel 110 can be communicated to a merchant kiosk 120, and the merchant kiosk 120 can communicate such data to the use-tracking server 130. For example, the vessel 110 can communicate such data via an RFID device that is interrogated by the merchant kiosk 120; the vessel 110 can comprise or generate a barcode on the display 230 (e.g., unique identifier 240) that comprises the encoded data, which can be scanned by the merchant kiosk 120; the vessel 110 can communicate the data to the kiosk 120 via near field communication (NFC), or the like. Accordingly, in various embodiments, the merchant kiosk 120 or other suitable devices can include devices for reading or scanning barcodes, interrogating RFIDs, and the like.

In yet another example, the vessel 110 can communicate such data to a user's smartphone via any suitable communication method and the smartphone can communicate the data to the use-tracking server 130. In a further example, the vessel 110 can be configured to connect to the internet via a WiFi network, when possible, and communicate the data to the use-tracking server 130. In various embodiments, any such communications can occur automatically without user interaction or can be triggered by user interaction.

In some embodiments, identifying use-events based on received data can occur automatically without user interaction. However, in further embodiments, identifying use-events can occur with user interaction and/or can be based on user input. For example, a user can indicate a use-event via an interface on the vessel 110 and/or another suitable device. In some embodiments, one or more pending use-events can be identified automatically and a user can verify and/or modify such pending use-events via the vessel 110 and/or another suitable device.

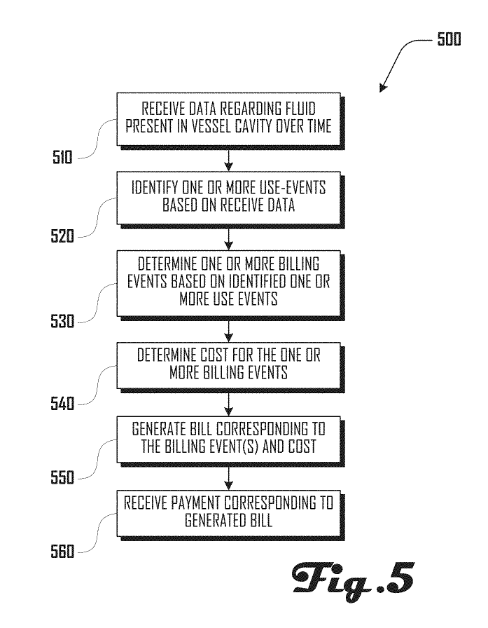

Turning to FIG. 5, a method 500 of billing use-events of a vessel 110 is disclosed. The method 500 begins in block 510, where data regarding fluid present in a vessel cavity 206 over time is received. For example, as discussed above, data regarding fluid present in the vessel cavity 206 can comprise information such as fluid temperature, fluid weight, fluid fill level, fluid volume, density of the fluid, a type of fluid, and the like.

In block 520, one or more use-events are identified from the data regarding fluid present in the vessel cavity 206. For example, where a fill sensor 220 and temperature sensor 235 indicate that the vessel cavity 206 was empty for a first period of time, was filled with 12 ounces of liquid that was initially 180° F. for a second period of time such a set of data could be determined to be associated with a use-event of a user obtaining 12 ounces of coffee or tea.

However, where a fill sensor 220 and temperature sensor 235 indicate that the vessel cavity 206 was empty for a first period of time, was filled with 24 ounces of liquid that is 40° F. for a second period of time, such a set of data could be determined to be associated with a use-event of a user obtaining a cold beverage from a soda fountain or other cold drink dispenser.

In other examples, scanning a barcode or interrogating an RFID (e.g., a unique identifier 240) can be associated with a volume of fluid disposed in a vessel cavity 206 over time. For example, a single scan or interrogation of a barcode or RFID can be associated with twelve ounces of fluid being present and removed over a period of time.

In block 530, one or more billing events based on the one or more use-events is determined, and at block 540, a cost for the one or more billing events is determined. At block 550 a bill corresponding to the one or more billing events is generated, and at block 560, payment corresponding to the generated bill is received.

For example, in one embodiment, data can be received at a merchant kiosk 120 from a vessel 110, which can include data regarding fluid present in the vessel 110 over time and/or use-events based on such data. The merchant kiosk 120 (and/or a merchant server 150 associated with the merchant kiosk 120) can determine billing events and bill a user accordingly. The merchant kiosk 120 can present the user with a bill or charge and receive payment via a suitable method including, cash, credit card, debit card, bitcoin, or the like.

For example, in one embodiment, a user can enter a merchant location with an empty vessel 110, fill it with coffee at the merchant location, and be charged for the amount of coffee based on information communicated from the vessel 110. In various embodiments, a user can be charged for different types and amounts of beverages based on data from the vessel 110. For example, hot and cold beverages can have different billing rates per volume and such rates can be charged to a user based on temperature and volume data from the vessel 110, or the like.

In a further example, use over time can be tracked and billed. For example, a user can obtain coffee from a merchant location multiple times during a week and can be billed for a total volume of coffee obtained over the week instead of per-use.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A vessel use tracking system comprising:
a plurality of portable and hand-held use tracking vessels that each comprise:
a vessel body that defines a vessel cavity via sidewalls;
a level sensor to sense an amount of liquid present within the vessel cavity;
a power source;
a processor;
a memory; and
a wireless communication device to communicate data,
wherein the vessel obtains and stores data indicating a volume of fluid present in the vessel cavity over time, and
a vessel use tracking computing device that:
wirelessly receives data from the plurality of vessels via the wireless communication devices indicating a volume of fluid present in the respective vessel cavities of the vessels over time;
identifying one or more use-events associated with the respective vessels based at least in part on the received data indicating a volume of fluid present in the respective vessel cavities of the vessels over time;
determining an amount of resource savings associated with the respective vessels based at least in part on the one or more identified use-events;
determining one or more billing events associated with the respective vessels based at least in part on the one or more identified use-events;
determining a cost for the one or more billing events;
generating one or more bills corresponding to the one or more billing events; and
receiving payment corresponding to the generated one or more bills.

2. The vessel tracking system of claim 1, wherein the plurality of vessels each further comprise:
a temperature sensor that senses a temperature of liquid disposed within the vessel cavity of the vessel body;
a display;
a biometric scanner; and
a pressure sensor that senses a pressure associated with liquid disposed within the vessel cavity of the vessel body.

3. The vessel tracking system of claim 2, wherein the display comprises at least one of a touch screen display, a back-lit screen, or LED screen.

4. The vessel tracking system of claim 2, wherein the biometric scanner comprises a fingerprint reader.

5. The vessel tracking system of claim 2, wherein the power source, processor, memory, communication device and pressure sensor are disposed in a base unit that is removably coupled to a bottom end of the vessel body.

6. The vessel tracking system of claim 1, wherein the vessels further comprise at least one of a line barcode, a matrix barcode or RFID associated with a unique identifier, and
wherein the computing device further obtains unique identifiers associated with the vessels based at least in part on a scan or interrogation of the line barcode, matrix barcode or RFID associated with the vessels; and
wherein the identifying one or more use-events associated with the respective vessels is further based at least in part on obtaining the unique identifiers.

7. The vessel tracking system of claim 1, wherein the plurality vessels are defined by coffee mug vessels that are configured to hold hot and cold beverages within the vessel cavity of the vessel body.

8. A use-tracking vessel that comprises:
a vessel body that defines a vessel cavity via sidewalls;
a level sensor to sense an amount of liquid present within the vessel cavity;
a power source;
a processor;
a memory; and
a communication device to communicate data,
wherein the vessel obtains and stores data indicating a volume of fluid present in the vessel cavity over time.

9. The use-tracking vessel of claim 8, wherein vessel further comprises a temperature sensor that senses a temperature of liquid disposed within the vessel cavity of the vessel body.

10. The use-tracking vessel of claim 8, wherein the vessel further comprises a display.

11. The use-tracking vessel of claim 8, wherein the vessel further comprises a biometric scanner.

12. The use-tracking vessel of claim 8, wherein the vessel further comprises a pressure sensor that senses a pressure associated with liquid disposed within the vessel cavity of the vessel body.

13. The use-tracking vessel claim 8, wherein the power source, processor, memory and communication device are disposed in a base unit that is removably coupled to the vessel body.

14. The use-tracking vessel of claim 8, wherein the vessel further comprises at least one of a line barcode, matrix barcode or RFID associated with a unique identifier.

15. The use-tracking vessel of claim 8, wherein the vessel is defined by a portable and hand-holdable coffee mug vessel that is configured to hold hot and cold beverages within the vessel cavity of the vessel body.

16. A computer implemented method of vessel use tracking, the method comprising:
obtaining data from a plurality of vessels indicating a volume of fluid present in respective vessel cavities of the vessels over time; and
identifying one or more use-events associated with the respective vessels based at least in part on the obtained data indicating a volume of fluid present in the respective vessel cavities of the vessels over time.

17. The method of vessel use tracking of claim 16, further comprising:
determining one or more billing events associated with the respective vessels based at least in part on the one or more identified use-events;
determining a cost for the one or more billing events;
generating one or more bills corresponding to the one or more billing events; and
receiving payment corresponding to the generated one or more bills.

18. The method of vessel use tracking of claim 16, further comprising determining an amount of resource savings associated with the respective vessels based at least in part on the one or more identified use-events.

19. The method of vessel use tracking of claim 16, wherein obtaining data from a plurality of vessels indicating a volume of fluid present in respective vessel cavities of the vessels over time comprises at least one of:
obtaining data comprising data from level sensors sensing an amount of liquid present within the respective vessel cavities the vessel, or
obtaining a unique identifier based at least in part on a scan or interrogation of a line barcode, matrix barcode or RFID of the respective vessels.

20. The method of vessel use tracking of claim 19, further comprising obtaining from the plurality of vessels:
temperature data obtained from a temperature sensor of the vessels that senses a temperature of liquid disposed within the vessel cavities of the respective vessel bodies,
biometric scanner data obtained from a biometric scanner disposed on the respective vessels, and
pressure sensor data obtained from a pressure sensor that senses a pressure associated with liquid disposed within the vessel cavities of the respective vessel bodies.
